(19) United States
(12) Patent Application Publication
(10) Pub. No.: US 2015/0108138 A1
(43) Pub. Date: Apr. 23, 2015

(54) DUAL COMPARTMENT TANK

(71) Applicant: RENAULT s.a.s., Boulogne-Billancourt (FR)

(72) Inventors: Joao Henrique De Paiva Kenicke, Curitiba (BR); Ronal Klostermann, Curitiba (BR); Gustavo Thomaz, Curitiba (BR); Alexandre Nunes, Curitiba (BR); Julio Silva, Curitiba (BR)

(73) Assignee: RENAULT s.a.s., Boulogne-Billancourt (FR)

(21) Appl. No.: 14/398,052

(22) PCT Filed: Apr. 24, 2013
(86) PCT No.: PCT/FR13/50912

§ 371 Date: Oct. 30, 2014

(30) Foreign Application Priority Data
Apr. 30, 2012 (FR) 1253969

(51) Int. Cl. B60K 15/06; B60P 3/24

(52) U.S. Cl. CPC B60K 15/06; B60P 3/24
USPC 220/564

(57) ABSTRACT

The invention concerns a tank (1) for a motor vehicle comprising an outer casing (10) delimiting an inner volume, the casing (10) comprising two portions, a bottom portion (19) and a cover portion (18), securely attached to each other in a sealed manner, characterised in that said casing (10) comprises an inner partition (40) made in one piece with the casing (10), said partition (40) separating the inner volume into two sealed compartments (20 and 30), which inner separating partition (40) extends from the bottom portion (19) and the cover portion (18). The invention also concerns a motor vehicle comprising such a tank.

The invention relates to a tank having at least two sealed compartments for motor vehicles.

One of the improvements sought in motor vehicles lies in the arrangement of their various elements or components, in order to avoid an excessive bulk of the various compartments of the vehicle, in particular the engine compartment.

Specifically, owing to the improvements of the various elements, such as the air-conditioning devices, the washer tanks, the “turbo” devices, and their add-ons in the engine compartment, it is necessary to adapt their structure and shape to the configuration surrounding them.

Furthermore, in order to ensure maximum safety of the vehicle cabin in the event of a front or side impact and to comply with local legislation in terms of safety, there are provided free spaces which can contribute to absorb these impacts.

The free spaces in question are provided to avoid, in particular, the crushing of the gasoline tank in the event of impact, which may cause undesirable leaks. For example, there are empty spaces between two suspension columns which can prevent the deformation of the outer part of the body in the event of a front or side impact. These empty spaces can also be provided to limit the harmful consequences to the pedestrian in the event of an impact.

Therefore, the presence of these free spaces requires adaptation of the elements constituting in particular the engine compartment, both on the operational level and on the conformational level.

The technological development of new engines, such as hybrid engines (gasoline/electricity) or engines operating with other fuels obtained in particular from plant sources, such as ethanol or the like, constitutes an additional source of bulk for the engine compartment by the presence of elements necessary for their operation.

In particular, for vehicles operating with fuels obtained from plants, such as ethanol, in a mixture with conventional gasoline, there is provided, apart from the ethanol tank, a conventional additional gasoline tank required for the cold-starting of such engines.

However, the presence of the additional gasoline tank, although necessary, has the disadvantage of a loss of free space in the engine compartment, and there is a need to improve the arrangement of the various components of said engine compartment.

These disadvantages are increased by the positioning of a washer tank, which is usually arranged in the engine compartment.

With the reduction in the size and the increase in the number of parts of the engine compartment, it is still, however, necessary to find solutions to reduce the total volume of the components, in order in particular to ensure the presence of empty spaces guaranteeing safety in the event of impacts.

Document U.S. Pat. No. 6,026,974 describes an adaptation of the gasoline tank comprising a gasoline tank and a fluid tank, in particular a washer tank, and fastening means for juxtaposing the two tanks. The gasoline tank has an empty space able to receive the fluid tank and notches having the form of channels so that the fluid tank can be positioned by sliding, and said tank being surrounded by three faces of the gasoline tank. However, such an arrangement is relatively complex and costly to implement.

The invention aims to overcome at least one of the disadvantages mentioned above by providing a motorcar tank comprising an outer casing delimiting an inner volume, the casing comprising two portions, a bottom portion and a cover portion, secured to one another in a sealed manner, characterized in that said casing comprises an inner partition made in one piece with the casing, said partition separating the inner volume into two sealed compartments, which inner separating partition extends from the bottom portion and the cover portion.

Thus, the production of a tank having two sealed compartments thanks to the inner separating partition has multiple advantages and provides multiple effects.

The first advantage lies in a reduction of the volume occupied by such a tank, in particular in the engine compartment, since each compartment of the tank can advantageously contain fluids of different type, which avoids the presence of two independent individual tanks, each intended for a different use. One of the two compartments can be configured to contain conventional gasoline required for starting an engine operating with a fuel obtained from plant sources, such as ethanol or the like, in a mixture with conventional gasoline, and the other of the compartments being provided to contain another fluid, such as a washer fluid.

Sealing of the two compartments via the inner separating partition must be ensured to avoid the undesirable mixture of fluids, in particular when they are of different chemical type, which, in the contrary case, may adversely affect the functionality of each compartment and seriously damage the correct operation of the vehicle.

The reduction in the volume of the tank advantageously makes it possible to maintain the empty spaces, in particular in the engine compartment, thereby making it possible to reduce the damage caused by impacts, as indicated above.

Other advantages lie in the reduction of manufacturing costs and/or in time savings when assembling such a tank. There can thus be provided only one line for manufacturing the tank and/or only one line for assembling it in the vehicle.

According to advantageous embodiments, the bottom and cover portions of the casing have complementary sealing edges configured to be secure to one another in a sealed manner for delimiting the inner volume of the casing.

The outer casing of the tank according to the invention is not limited in dimension or in geometry, provided that the effects and advantages of the invention are complied with.

The size and the configuration of the outer casing constituting the tank are advantageously provided and configured according to the environment surrounding it, for example as a function of the type of body of the motor vehicle and according to the shape and size of the other components present, and, more generally, in order to be optimized and adapted to the surrounding space.

The casing may be of any geometric shape, which shape delimits the inner volume of the casing by a plurality of outer faces, advantageously numbering six, two lower and upper faces and four other faces preferably forming a substantially rectangular or parallelepipedal structure, the ends of which may be rounded. Two faces, termed lateral faces, which may or may not be parallel to one another, may respectively constitute faces for fastening the tank to vehicle body elements or to parts of the engine compartment via fastening lugs. Two other faces, termed longitudinal faces, which may or may not be parallel to one another, may have respective lengths equal to or greater than the respective lengths of the lateral faces and are advantageously configured to receive components of the tank, such as pumps for discharging fluids contained in each compartment of the tank, means for discharging fluids, connections, seals and fluid level sensors.

The longitudinal and/or lateral faces of the tank may have variable shapes, both planar and nonplanar.

According to one embodiment, the bottom and cover portions may be formed by an upper and lower face respectively and the lateral and longitudinal faces being separate.

These lateral and longitudinal faces and the bottom and cover portions may then be delimited by complementary sealing edges which allow the subsequent securing and fastening of said faces and portions by the respective sealing edges, in order to form the casing, for example by welding or adhesive bonding. The sealing edges thus extend over the whole periphery of the casing.

However, this embodiment is not preferred since it requires a plurality of portions and faces to be secured to one another.

In another embodiment, the bottom and cover portions may advantageously form two half-casings, each half-casing being able to comprise two lateral and longitudinal half-faces which are then secured to one another for example by welding or adhesive bonding, to produce the casing. This configuration allows easy manufacture of the casing, for example by extrusion of a polymer material.

The bottom and cover portions may be secured to one another in a substantially parallel manner in a horizontal direction, or not.

The inner partition for separating the inner volume into two sealed compartments extends from the bottom portion and the cover portion, with the result that the inner separating partition may be fastened either to the bottom portion or to the cover portion prior to securing said bottom and cover portions to one another. Fastening may be achieved by conventional techniques, such as adhesive bonding or welding.

The inner partition may also be made in two parts, one fastened to the bottom portion and the other fastened to the cover portion, these two parts being configured to be in sealed contact when the bottom and cover portions are secured.

In particular, these two parts of the inner partition may be secured to one another, for example by adhesive bonding or welding, when securing the bottom and cover portions.

Advantageously, the inner partition, when it is in one part is made in one piece with one of the bottom or cover portions, and when it is made in two parts, each of the parts is secured with one of the bottom and cover portions.

The inner separating partition is advantageously configured to separate the tank into two compartments along an axis substantially parallel to the lateral faces.

Each compartment may have an identical or else different volume.

The inner separating partition of the casing is advantageously formed by at least two substantially parallel walls.

Such an arrangement ensures increased sealing between the two compartments.

Advantageously, two substantially parallel walls form the inner separating partition.

Each wall of the inner separating partition is then a wall delimiting in a sealed manner the respective inner volume of each compartment.

According to one embodiment, said walls are secured to one another, in contact via their respective faces, which faces may have planar or wavy complementary shapes according to the geometry of the casing.

According to advantageous embodiments of the invention, the two walls are separated from one another by a predetermined distance, defining an inter-wall space, the casing comprising at least one through-orifice opening into the inter-wall space.

The inter-wall space defines, according to this arrangement, an empty space such that there can be provided an orifice preferably situated on the upper or lower part of the casing, which orifice passes through the thickness of the casing at the level of the inter-wall space.

The presence of such an orifice arranged to communicate between the space separating these double walls and the external environment makes it possible to discharge a fluid which would be spread from at least one of the compartments toward the inter-wall space in use, and makes it possible to facilitate sealing tests on the two compartments during manufacture. This still further optimizes the functionality of the two compartments and guarantees to the user that the tank is operating correctly. The orifice preferably extends over at least part of the periphery of the separating partition.

The orifice is advantageously a slot extending over at least part of the casing and opening into the inter-wall space in order to conjointly allow the possible discharge of a fluid being spread in the inter-wall space, avoid undesirable pollution of the inter-wall space by dust or fluids from the external environment and allow an inlet of air intended to dry said space.

The slot preferably extends over part of the casing just necessary to obtain the desired effects, and it may represent a dimension (length) of between 1/50 and 1/10 of that of the separating partition.

Typically, said slot, which may have a circular, rectangular, square, oval or other shape, has a dimension (length and/or width) of a few millimeters, for example from 2 to 5 mm. The slot may be provided at its surface with a mesh screen of variable dimensions to avoid, in an increased manner, pollution of the inter-wall space by dust from the external environment.

Preferably, the inter-wall space is typically in the range of values situated between 1 and 5 mm.

According to advantageous embodiments, the outer casing has a thickness delimiting the inner part of said casing. This thickness is conventional for this type of tank, and it may be a few millimeters.

The tank is advantageously made of a polymer material compatible with each fluid intended to be contained in each respective compartment.

Such a material limits production costs and allows easy positioning of the tank in particular in the engine compartment that is connected with the flexibility of the material which is associated therewith.

The chemical nature of the polymer material is not limited, provided that it can be adapted to the fluids which can be contained in each compartment. It is advantageous that the reservoir is made of a single polymer material, common to the compartments and to the separating partition, in order to limit production costs.

Mention may be made of polymers or copolymers based on polyethylene or the like, such as high-density polyethylene (HDPE).

The tank may be manufactured by any technique known to a person skilled in the art, injection molding being preferred in terms of ease of implementation and of costs.

When the tank is intended to be made of polymer material, securing, if appropriate, of the various portions and faces and/or of the inner separating partition is then carried out by welding so as to ensure that they are sealed.

In a conventional way, the tank comprises the standard elements or components which are associated therewith, allowing its operational use.

Among these components, mention may be made of fluid discharge pumps, such as water pumps or gasoline pump, means for fastening and retaining the pumps on the tank or casing, orifices for filling each compartment, caps for closing the filling orifices, means for transferring fluids for an indicated use, such as pipes, seals for various components, anti-vibration seals, anti-noise seals and the like.

Advantageously, on one of the longitudinal faces, each compartment defines over one of its lengths, which is delimited by an end of the inner separating partition, hollows or depressions forming housings for fluid pumps, in order to optimize the empty spaces, in particular in the engine compartment.

The housings for fluid pumps are configured to conventionally have shapes complementary to the outer walls of said pumps, and these housings are not limited in shape. Generally, the housings have a curved surface matching, for example, the shape of a cylinder, since fluid pumps can usually have a substantially cylindrical shape.

The casing may additionally comprise means for fastening and retaining the fluid pumps, preferably arranged on either side of the housings for the pumps, and intended to cooperate with complementary fastening and retaining means provided on each fluid pump. These means for fastening and retaining the pumps may be snap-fastening means. For example, they may be lugs projecting from the pumps, defining through-orifices, arranged to cooperate with studs projecting from the casing.

Each pump may then be fastened and retained against the housing, for example by simple snap-fastening.

Advantageously, each pump may be provided with an anti-noise seal, in order to attenuate the noise nuisance from the tank during the operation of the vehicle. The anti-noise seal is usually made of suitable polymer foam.

There may also be provided anti-vibration seals arranged on each pump and/or on the lugs for fastening the tank to the vehicle, which lugs are preferably situated on the lateral faces of the tank, thereby increasing user comfort further still.

The various means for fastening and retaining the pumps and/or the lugs for fastening the tank to the vehicle may be advantageously made in one piece with the casing.

The filling orifices for each compartment are preferably placed at a distance from the inner separating partition such that the inner separating partition can be secured, in particular by welding, to one of the bottom and cover portions without damaging the integrity of the filling orifices. The orifices conventionally comprise a protuberance projecting from the tank.

Another subject of the invention is a motor vehicle comprising an engine operating with a fuel obtained from plants, comprising a tank according to the invention, one of the compartments being connected to the engine to supply it with gasoline, the other compartment being connected to a washer system.

Thus, by virtue of the tank according to the invention, provision may be made to combine two sealed compartments separated by a separating partition, each compartment being filled with a fluid providing a different functionality. One of the compartments comprises conventional gasoline intended to start up the engine, which is intended to operate with a fuel obtained from plants, such as ethanol, in particular in a mixture with conventional gasoline. The other compartment is a washer compartment comprising a fluid suitable for washing windshield glass and/or glazed walls of headlamps.

The tank is very advantageously placed in the zone delimited by the engine compartment, for example, in the water box, and is configured to occupy the least possible space, in particular the space occupied by the tank being less than the space occupied by the two individual gasoline and washer tanks. This makes it possible to maintain inner empty spaces in the engine compartment for reasons of safety in the event of an impact.

The inner partition separating the two compartments avoids the mixture of the two fluids, which are immiscible in the majority of cases. The possible mixing thereof would have as consequence a serious risk of damaging the washer and/or engine supply systems.

Preferably, the volume of the gasoline compartment is smaller than that of the washer compartment.

The invention is now described in more detail with reference to the nonlimiting appended drawings, in which:

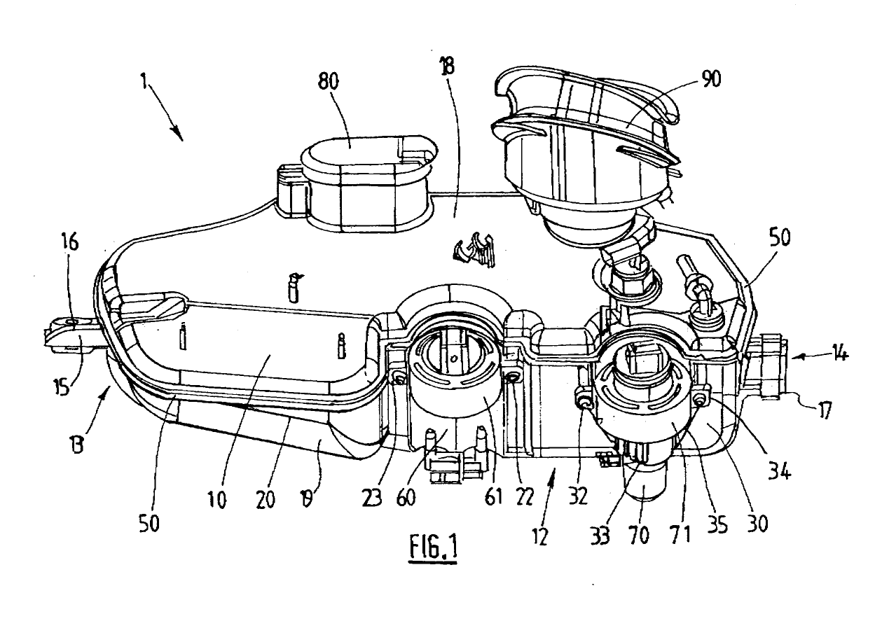

FIG. 1 represents a perspective view of a tank according to one embodiment of the invention,

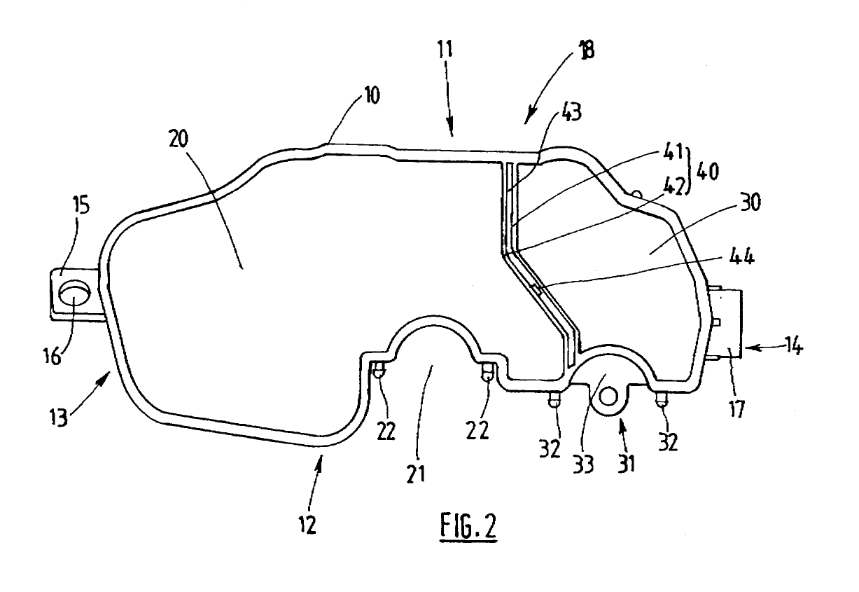

FIG. 2 is a plan view of the bottom portion of the tank represented in FIG. 1.

By substantially rectangular or parallelepipedal, vertical or horizontal, is meant a direction/a plane forming an angle of at most ±30° with a direction/a plane perpendicular or parallel to another direction/another plane.

FIG. 1 shows a perspective view of a tank 1 comprising an outer casing 10 delimiting an inner volume, the casing 10 being made in two portions, a cover portion 18 and a bottom portion 19, secured in a sealed manner by welding along a sealing edge 50 which extends over the whole periphery of the casing 10.

The casing 10 is made of HDPE.

As referenced in FIG. 2, the casing 10 has two longitudinal faces 11, 12 which are substantially parallel to one another. Here, each longitudinal face 11, 12 has a nonplanar outer shape adapted to allow the tank 1 to be housed in the engine compartment while being adapted to the surrounding environment. Two lateral faces 13, 14 are substantially parallel to one another and connected to the longitudinal faces 11, 12. They also have a nonplanar outer shape.

The tank 10 comprises two respective compartments 20, 30, one of the compartments 20 being intended to receive a fluid for washing the windshield and the other compartment 30 being intended to receive gasoline.

The compartments 20, 30 are respectively provided with filling orifices 80, 90 for the windshield washing liquid and for the gasoline, these orifices being situated on the cover portion 18 and made in one piece therewith.

As represented in FIG. 1, the compartment 20 containing a windshield washing fluid has a flared shape, that is to say that, in a direction extending toward the lateral face 13, the bottom portion 19 is not parallel with the cover portion 18, with the result that, in this direction, the volume of the compartment 20 decreases. These compartments 20, 30 are separated by an inner separating partition 40, here having a zig-zag shape, made in one piece with the casing 10, which inner separating partition 40 extends from the bottom portion 19 and the cover portion 18 (not shown in FIG. 2). In the example represented, with reference to FIG. 2, the inner separating partition 40 is in two parts, one secured to the bottom portion 19 and the other secured to the cover portion 18 (not shown). These two parts are configured to be in sealed contact when the bottom 19 and cover 18 portions are secured in a sealed manner.

As can be seen in FIG. 2, the inner separating partition 40 of the casing is formed by two substantially parallel walls 41, 42, each wall 41, 42 of the inner separating partition 40 being a wall delimiting the respective inner volume of each compartment 20, 30. The two walls 41, 42 are separated from one another by a distance of 5 mm (the representation is not to scale), defining an inter-wall empty space 43.

The inter-wall space 43 of the casing 10 comprises a through-orifice 44 opening into the inter-wall space 43. In FIG. 2, this orifice 44 is in the lower part of the inner partition 40 and is therefore pierced in the lower part of the casing 10. However, it may be in the upper part of the inner partition 40 and pierced in the upper part of the casing 10 (not shown).

As can be seen in FIG. 2, one of the longitudinal faces 12 comprises, over its length on the outer side of the casing 10 at the height of the compartment 20, a housing 21 of semicylindrical shape. On either side of the recess 21, means 22 for fastening and retaining a pump for a windshield washing fluid (not shown) are secured to the casing 10.

One of the longitudinal faces 12 comprises, over its length on the outer side of the casing 10 at the height of the compartment 30, a housing 31 of semicylindrical shape. On either side of the housing 31, means 32 for fastening and retaining a gasoline pump (not shown) are secured to the casing 10. A means 33 for supporting the gasoline pump is fastened to the casing 10 on the lower part of the longitudinal face 12 of the casing 10.

In the example represented, the fastening and retaining means 22 and 32 are studs which project from the casing 10 and of which the free end is widened.

Each lateral wall 13, 14 is provided, on the outer side of the casing 10, with fastening lugs 15, 17 respectively for fastening the tank 1 to the vehicle body elements or to the parts of the engine compartment (not shown in the figures). The fastening lug 15 defines a through-orifice 16 intended to contain a means for securing the tank 1 to the parts of the engine compartment, such as a screw, rivet or the like.

As represented in FIG. 1, a pump 60 for discharging windshield washing fluid is fastened inside the housing 21 (not shown in FIG. 1) of the lateral face 12 in the region of the compartment 20, and the pump 60 is retained by the fastening means 22 which cooperate with through-orifices defined in lugs 23 secured to the pump 60 and projecting therefrom. The upper part of the pump 60 is provided with an anti-noise seal 61. The pipes for discharging the fluid toward the windshield have not been represented.

A gasoline discharge pump 70 is fastened against the housing 31 (not shown in FIG. 2) of the lateral face 12 in the region of the compartment 30, and the pump 70 is retained by the fastening means 32 cooperating with through-orifices defined in lugs 34 secured to the pump 70 and projecting therefrom. The upper part of the pump 70 is provided with an anti-noise seal 71. The pump 70 is supported by a support means 33, here a plate 33 secured to the casing 10. The pump 70 is surrounded by flexible metal wires 35 of which each end is fastened to the fastening means 32. The pipes for discharging gasoline toward the engine have not been represented.

1. A motorcar tank comprising an outer casing delimiting an inner volume, the casing comprising two portions, a bottom portion and a cover portion, secured to one another in a sealed manner, characterized in that said casing comprises an inner partition made in one piece with the casing, said partition separating the inner volume into two sealed compartments, which inner separating partition extends from the bottom portion and the cover portion.

2. The tank as claimed in claim 1, in which the inner separating partition of the casing is formed by at least two substantially parallel walls.

3. The tank as claimed in claim 2, in which each wall of the inner separating partition is a wall delimiting in a sealed manner the respective inner volume of each compartment.

4. The tank as claimed in claim 2, in which the two walls are separated from one another by a predetermined distance, defining an inter-wall space, the casing comprising at least one through-orifice opening into the inter-wall space.

5. The tank as claimed in claim 4, in which the orifice is a slot extending over at least part of the casing and opening into the inter-wall space.

6. The tank as claimed in claim 1, which is made of a polymer material compatible with each fluid intended to be contained in each respective compartment.

7. The tank as claimed in claim 1, in which, on one of the longitudinal faces, each compartment defines over one of its lengths, which is delimited by an end of the inner separating partition, hollows or depressions forming housings for fluid pumps.

8. The tank as claimed in claim 1, in which the casing additionally comprises means for fastening and retaining the fluid pumps and intended to cooperate with complementary fastening and retaining means provided on each fluid pump.

9. A motor vehicle comprising an engine operating with a fuel obtained from plants, comprising a tank as defined in claim 1, one of the compartments being connected to the engine to supply it with gasoline, the other compartment being connected to a washer system.
